(19) United States
(12) Patent Application Publication
(10) Pub. No.: US 2015/0102567 A1
(43) Pub. Date: Apr. 16, 2015

(54) TOOL JOINT

(71) Applicant: FU-YI CHAN, Taichung (TW)

(72) Inventor: FU-YI CHAN, Taichung (TW)

(21) Appl. No.: 14/054,874

(22) Filed: Oct. 16, 2013

(51) Int. Cl. B25B 23/00; B23B 31/22

(52) U.S. Cl. CPC B25B 23/0035; B23B 31/22
USPC 279/75; 279/74

(57) ABSTRACT

A tool joint is revealed. The tool joint includes a first main body, a second main body, locking members and a sleeve set. The first main body consists of a mounting part, a stopping part and a rear part. The second main body is disposed in the mounting part and having a polygonal assembly slot penetrating the second main body. Insertion holes are disposed close to an opening end of the assembly slot. The second main body is a polygonal column whose shape matches that of the polygonal assembly slot. The locking member is against the stopping part. The sleeve set is mounted in the assembly slot. The tool joint features on that the second main body is unable to rotate radially in the mounting part by the polygonal column design of the second main body locked with walls of a polygonal slot of the mounting part.

### BACKGROUND OF THE INVENTION

1. Fields of the Invention

The present invention relates to a tool joint, especially to a tool joint that connects to passive tools such as screwdrivers. The tool joint includes a first main body, a second main body, locking members and a sleeve set. The second main body and the sleeve set are movable in the first main body elastically and axially. The assembly of the above components is easy.

2. Descriptions of Related Art

Refer to U.S. Pat. No. 3,398,965, a quick change tool holder is revealed. A tool holder includes a shank member and a tubular tool receiving bushing. The shank member has a tapered portion and an open ended tubular portion with a cylindrical inner wall in which the tubular tool receiving bushing has a sliding fit. An inner end of the tubular portion of the shank is a non-cylindrical tool driving portion adapted to receive the end of a tool. Three circumferentially spaced apart ball retaining apertures are extending through the wall of the tool receiving bushing. The apertures are adapted to receive and retain tool gripping balls and have their inner ends of a reduced diameter which is smaller than the diameter of the tool griping balls. Thereby the tool gripping balls extend into tool receiving bore of the bushing to grip the tool. To insert a new tool, it is only necessary to push it into the bore of bushing with its driving end properly aligned with the non-cylindrical driving portion of the shank. However, the tool holder revealed in the U.S. Pat. No. 3,398,965 is only suitable for a sleeve workpiece with an extension end where the force is applied to. It's unable to be used for some backup driving parts such as stubby screwdriver. The rod of the screwdriver is unable to reach the inner end of the shank which is a non-cylindrical tool driving portion. Thus the tubular tool receiving bushing is idly rotated in the cylindrical inner wall of the shank and is unable to drive the screwdriver. This is due to that both the inner wall and the bushing are cylindrical. While driving the screwdriver, the idle rotation still occurs due to large torque, even there are three tool gripping balls moving radially into gripping engagement with the tool tightly.

### SUMMARY OF THE INVENTION

Therefore it is a primary object of the present invention to provide a tool joint that is connected to a drive connector of a screwdriver for overcoming the shortcomings mentioned above.

In order to achieve the above object, a tool joint of the present invention includes a first main body, a second main body, locking members, a sleeve set, a first elastic member, and a second elastic member. The second main body and the sleeve set are elastically movable in the first main body.

The first main body consists of a mounting part, a stopping part, and a rear part. The mounting part is a polygonal slot whose cross section is polygonal.

The second main body is set in the mounting part and having an assembly slot. The cross section of the assembly slot is hexagonal and the assembly slot is penetrating the second main body. At least one insertion hole is arranged at the assembly slot close to an opening end of the assembly slot while the other end of the second main body is disposed with a second leaning surface;

At least one locking member is mounted in the insertion hole and the locking member is leaning against the stopping part.

The sleeve set received in the assembly slot includes a receiving means with an against part. The diameter of the against part is larger than that of the receiving means and the against part is against the second leaning surface.

The first elastic member is leaning against the rear part and the second leaning surface. By elasticity of the first elastic member, the second main body is extended to be exposed more and the locking member is leaning against by a part of the stopping part with smaller diameter.

The second elastic member is leaning against the sleeve set and the bottom end of the mounting part. The elasticity of the second elastic member allows the against part leaning against the second leaning surface.

Compared with conventional tool joints, the assembly slot of the second main body of the present invention is mounted with a tool head. Then the tool head is locked by each locking member. Thus the tool head is mounted firmly, not easily falling off from the assembly slot of the second main body. The second main body is moved toward the bottom end of the mounting part of the first main body and each locking member is no more against the stopping part of the first main body. The receiving means is moved by elasticity of the second elastic member. Then the receiving means further pushes the tool head to move outward along the first main body axially. The tool head will not fall off from the assembly slot and the user can hold and move the tool head from the first main body manually. Thus the falling of the tool head from the assembly slot can be prevented. The second main body is received in the mounting part of the first main body. While the tool head being falling off, the second main body is protected by the first main body, without being bumped and the tool head is automatically released from the assembly slot of the second main body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment of a tool joint according to the present invention;

FIG. 2 is a partial cross sectional view of a first main body of an embodiment according to the present invention;

FIG. 2-1 is a partial enlarged view of an insertion hole of an embodiment according to the present invention;

FIG. 3 is a perspective schematic drawing of an embodiment according to the present invention;

FIG. 4 is a cross sectional view of a stopping part of an embodiment according to the present invention;

FIG. 5 is a cross sectional view of the embodiment in FIG. 2 along A-A′ line before being pressed according to the present invention;

FIG. 6 is a cross sectional view of the embodiment in FIG. 2 along A-A′ line after being pressed according to the present invention;

FIG. 7 is a schematic drawing showing a front view of another embodiment according to the present invention;

FIG. 8 is a side view of another embodiment according to the present invention;

FIG. 9 is a schematic drawing showing an embodiment in use according to the present invention;

FIG. 10 is another schematic drawing showing an embodiment in use according to the present invention.

### DETAILED DESCRIPTION OF THE PREFERRED EMBODIMENT

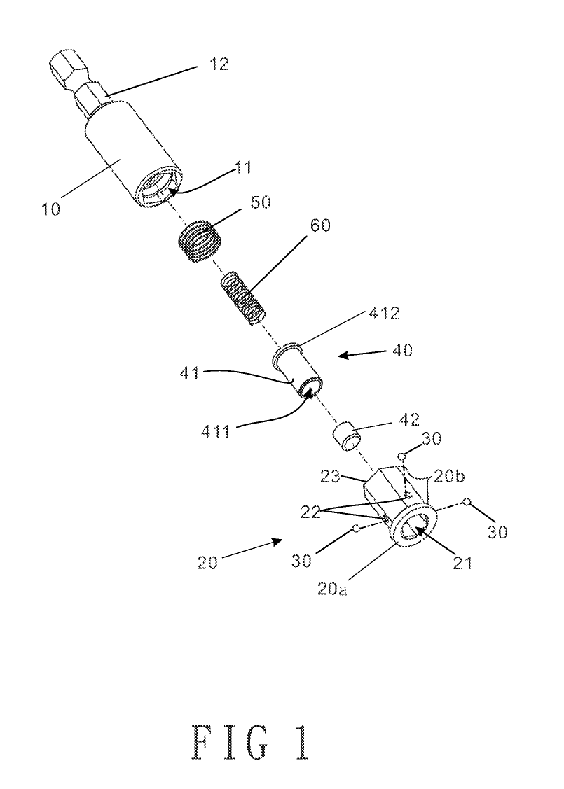

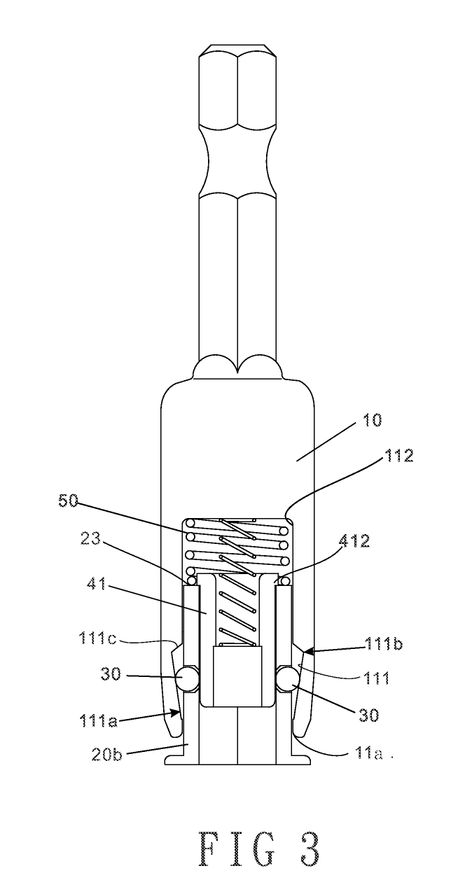

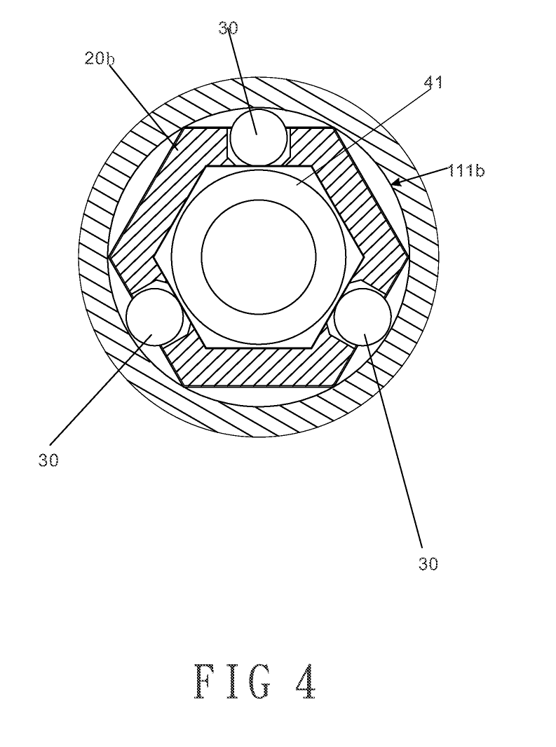

Refer from FIG. 1 to FIG. 4, a tool joint of the present invention includes a first main body 10, a second main body 20, at least one locking member 30, a sleeve set 40, a first elastic member 50, and a second elastic member 60.

One end of the first main body 10 is disposed with a mounting part 11 while the other end thereof is arranged with a driving part 12. The mounting part 11 consists of a front end 11a, a stopping part 111, and a rear part 112. The front end 11a is extended inward to form the stopping part 111 and the stopping part 111 is further extended to form the rear part 112. The front end 11a and the rear part 112 are polygonal slots with polygonal cross section. In this embodiment, the front end 11a and the rear part 112 of the mounting part 11 are slots with hexagonal cross section. The stopping part 111 close to an opening end of the mounting part 11 is a circular groove having a front segment 111a and a rear segment 111b. The diameter of the front segment 111a is smaller than that of the rear segment 111b. That means the stopping part 111 is tapered toward the opening end of the mounting part 11. The diameter of the rear segment 111b is larger than that of the rear part 112. Thus a step-like first leaning surface 111c is formed between the rear segment 111b and the rear part 112. In this embodiment, the driving part 12 is a hexagonal column.

The second main body 20 is formed by an enlarged end 20a and an action part 20b. The action part 20b is a polygonal column whose cross section is a polygon that matches the shape of the front end 11a and the rear part 112 of the mounting part 11 of the first main body 10. In this embodiment, the cross section of the action part 20b is hexagonal. The action part 20b is mounted in the mounting part 11. The second main body 20 is movable axially inside the mounting part 11. The second main body 20 is further disposed with an assembly slot 21 that is hexagonal and is penetrating the second main body 20. A circular body is arranged at a front end of the assembly slot 21 and the diameter of the circular body is larger than the diameter of inscribed circle of the mounting part 11. The enlarged end 20a on the front end of the assembly slot 21 is against and locked by an outer edge of the first main body 10. Close to an opening end thereof, the assembly slot 21 is disposed with at least one insertion hole 22 that communicates with the assembly slot 21. A second leaning surface 23 is set on the other end of the second main body 20, opposite to the opening end.

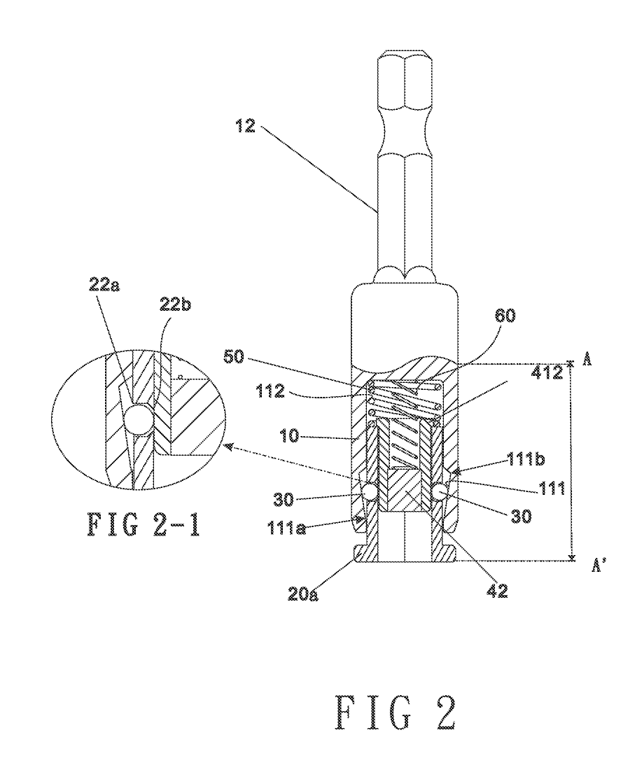

The locking member 30 is ball-shaped. The number of the locking members 30 is the same with that of the insertion holes 22 of the second main body 20. The locking member 30 is mounted into each insertion hole 22 correspondingly. Each locking member 30 is leaning against the stopping part 111 of the first main body 10. As shown in FIG. 2-1, the insertion hole 22 includes a first end 22a and a second end 22b. The diameter of the second end 22b is smaller than that of the first end 22a. The maximum diameter of the locking member 30 matches the diameter of the first end 22a while the diameter of the second end 22b is a bit larger than the minimum diameter of the locking member 30. Thereby an outer diameter of an outer end surface of the locking member 30 is a bit projecting from the second end 22b, without falling into the assembly slot 21.

The sleeve set 40 is a cylindrical column received in the assembly slot 21 of the second main body 20. The sleeve set 40 includes a receiving means 41 and a magnetic body 42. The receiving means 41 includes a receiving slot 411 and an against part 412 disposed on one end thereof. The diameter of the against part 412 is larger than that of the receiving means 41 and the against part 412 is against the second leaning surface 23. The magnetic body 42 is mounted in the receiving slot 411 and having magnetic attraction. The magnetic body 42 is aligned with the assembly slot 21.

The first elastic member 50 is received in the mounting part 11 of the first main body 10. One end of the first elastic member 50 is leaning against a bottom surface of the rear part 112 while the other end thereof is leaning against the second leaning surface 23. By elasticity of the first elastic member 50, the second main body 20 is extended to be exposed more and the locking member 30 is leaning against by a part of the stopping part 111 with smaller diameter.

The second elastic member 60 is mounted in the mounting part 11 of the first main body 10. One end of the second elastic member 60 is leaning against the sleeve set 40 while the other end thereof is leaning against the bottom surface of the rear part 112 of the first main body 10. The against part 412 of the receiving means 41 is leaning against the second leaning surface 23 of the second main body 20 by elasticity of the second elastic member 60.

Moreover, the second main body 20 is mounted in the mounting part 11 of the first main body 10 while the member 30 is mounted in the insertion hole 22 and is against the stopping part 111 of the first main body 10. The magnetic body 42 and the second elastic member 60 are received in the receiving means 41 of the sleeve set 40 while the second elastic member 60 is leaning against between the bottom of the first main body 10 and the magnetic body 42. One end of the first elastic member 50 is leaning against the bottom surface of the rear part 112 of the first main body 10 while the other end thereof is leaning against the second leaning surface 23 of the second main body 20. While the first main body 10 being driven, the second main body 20 is driven to rotate by the first main body 10.

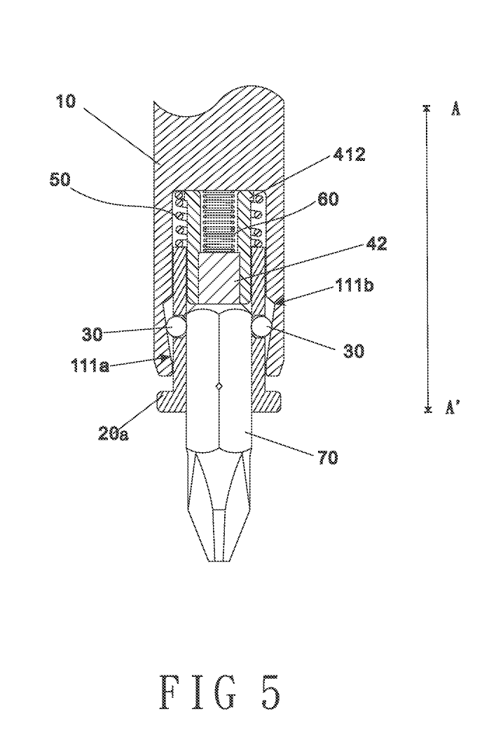

Refer to FIG. 5, a cross sectional view along A-A′ line of the embodiment in FIG. 2 before being pressed is revealed. A tool head 70 is mounted into the assembly slot 21 of the second main body 20. The tool head 70 is locked by each locking member 30 and is attracted by the magnetic body 42. Thus the tool head 70 is mounted firmly, not easy to fall off from the assembly slot 21. While being mounted into the assembly slot 21, the tool head 70 pushes the receiving means 41 so that the second elastic member 60 is further compressed.

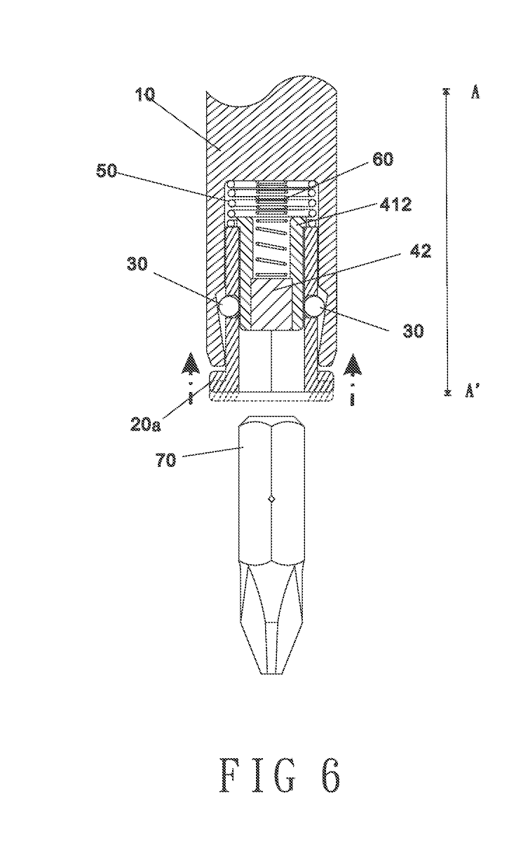

Refer to FIG. 6, a cross sectional view along A-A′ line of the embodiment in FIG. 2 after being pressed is disclosed. The second main body 20 is moved toward the bottom end of the first main body 10 and each locking member 30 is not against the stopping part 111 of the first main body 10. The elastic force of the second elastic member 60 is used to move the receiving means 41. The receiving means 41 further pushes the tool head 70 to move outward along the first main body 10 axially. The locking member 30 is pushed aside by the tool head 70 while the magnetic body 42 of the sleeve set 40 still attracts the tool head 70. Thus the tool head 70 will not fall off from the assembly slot 21. The tool head 70 is held and moved out from the first main body 10 manually by the user.

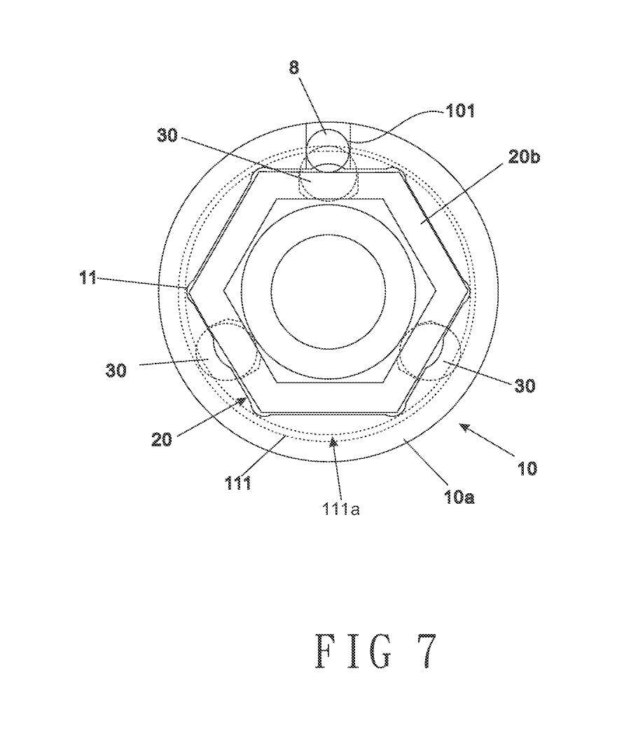

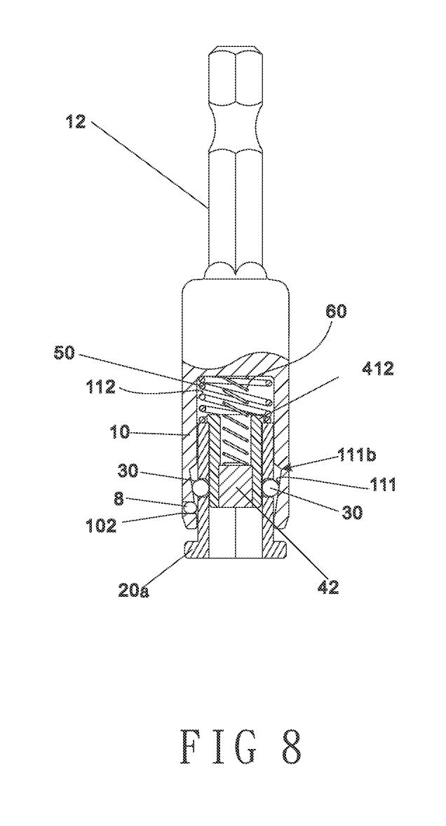

Refer to FIG. 7 and FIG. 8, another embodiment is revealed. A first main body 10 includes an assembly end 10a and a positioning hole 101 is arranged at a circumferential side of the assembly end 10a. The positioning hole 101 is used to load a fixing member 8. In this embodiment, the fixing member 8 is a steel ball whose diameter is a bit larger than that of the positioning hole 101. This embodiment features on that the fixing member 8 is pressed to be mounted into the positioning hole 101 by the user applying a certain pressure. Thereby the fixing member 8 is projecting from an end surface of the positioning hole 101 to lock locking members 30 of a second main body 20 and further prevent the second main body 20 from falling off from the first main body 10. Moreover, a front end 11a and a rear part 112 of the first main body 10 have the same diameter. The front end 11a and the rear part 112 are irregular-shaped slots whose cross section is irregular-shaped.

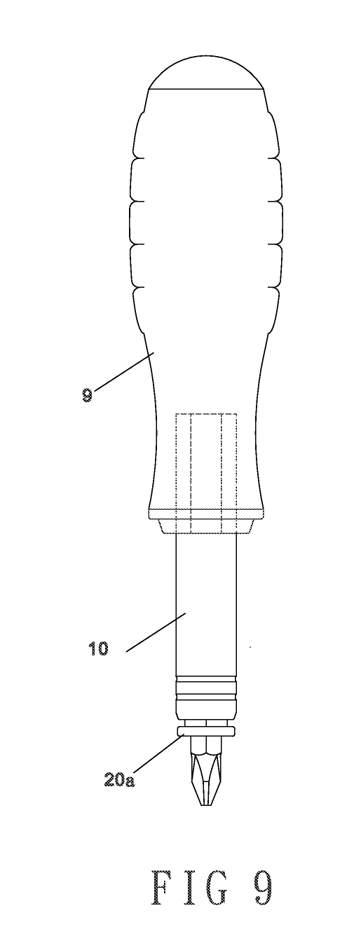

As shown in FIG. 9, an embodiment of the present invention assembled with a handle 9 is revealed. The first main body 10 is assembled with one end of the handle 9 by a rear end of the first main body 10 being connected to and held by the handle 9. Such assembly is for hand tools.

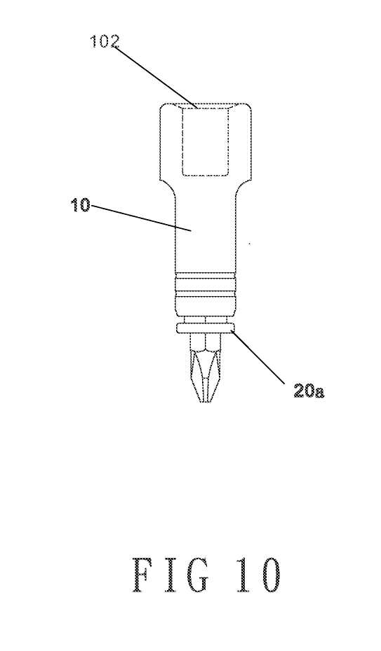

Refer to FIG. 10, a rear end of the first main body 10 is disposed with a driving part 102 that is a quadrilateral groove. Such design is for pneumatic tools.

The main advantage of the tool joint of the present invention is in that the cross section of the action part 20b of the second main body 20 is polygonal. The shape of the cross section of the action part 20b matches the shape of the cross section of the front end 11a as well as the rear part 112 of the mounting part 11 of the first main body 10. By the polygonal action part 20b being mounted into the front end 11a and the rear part 112 of the mounting part 11, the second main body 20 is able to move along the axial direction in the mounting part 11. Yet the second main body 20 is unable to rotate along the radial direction in the mounting part 11 due to the polygonal shape of the second main body 20 locked with the polygonal mounting part 11.

Moreover, the present invention further has other advantages:
1. A tool head 70 is mounted in the assembly slot 21 of the second main body 20. Then the tool head 70 is locked by each locking member 30 and is attracted by the magnetic body 42. Thus the tool head 70 is mounted firmly, not apt to fall off from the assembly slot 21 of the second main body 20.
2. The second main body 20 is moved toward the bottom end of the first main body 10 and the locking members 30 are arranged circularly. In an embodiment of the present invention, there are three locking members 30 disposed around the action part 20b of the second main body 20. Such design allows the second main body 20 not moving away from the axial direction in the mounting part 11 of the first main body 10 and further ensures smooth operation of the second main body 20.
3. The elasticity of the second elastic member 60 is used to move the receiving means 41 and the receiving means 41 further pushes the tool head 70 to move outward along the axial direction of the first main body 10. Due to the magnetic attraction of the magnetic body 42, the tool head 70 will not fall off from the assembly slot 21. The user can hold and move the tool head 70 from the first main body 10 manually. Thus the loss of the tool head 70 is prevented.
4. The second main body 20 is received in the mounting part 11 of the first main body 10. When the tool joint is falling off, the second main body 20 is protected by the first main body 10 and is not struck easily while the tool head 70 is automatically released from the assembly slot 21.
5. The second main body 20, the receiving means 41 and the magnetic body 42 can be assembled in advance and then is integratedly mounted in the mounting part 11. The assembly is convenient.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A tool joint comprising:
a first main body disposed with a mounting part at one end thereof; the mounting part including a front end close to an opening, and a stopping part that is a circular groove formed by the front end extended backward and having a front segment and a rear segment; wherein a diameter of the front segment is smaller than a diameter of the rear segment and a rear part is arranged at a bottom end of the mounting part; the front end and the rear part are polygonal slots whose cross section is polygonal;
a second main body that includes an enlarged end and an action part formed by the enlarged end extended backward; the action part is a polygonal column whose cross section is a polygon that matches a shape of the front end and the rear part of the mounting part of the first main body; the second main body is mounted in the mounting part and is movable axially inside the mounting part; the second main body is disposed with an assembly slot that is a polygonal slot penetrating thereof; at least one insertion hole is arranged at the assembly slot, close to an opening end of the assembly slot and the insertion hole communicates with the assembly slot; a second leaning surface is set on the other end of the second main body, opposite to the opening end of the second main body;
at least one locking member; the number of the locking member is the same with the number of the insertion hole of the second main body and the locking member is mounted in the insertion hole correspondingly;
a sleeve set received in the assembly slot of the second main body and having a receiving means with an against part; a diameter of the against part is larger than a diameter of the receiving means and the against part is against the second leaning surface;
a first elastic member arranged in the mounting part of the first main body and leaning against a bottom surface of the rear part of the first main body and the second leaning surface; the second main body is extended to be exposed more and the locking member is leaning against by a part of the stopping part with smaller diameter by elasticity of the first elastic member; and
a second elastic member disposed in the mounting part of the first main body and leaning against the sleeve set and the bottom surface of the rear part of the first main body; elasticity of the second elastic member allows the against part of the receiving means leaning against the second leaning surface of the second main body;
wherein the action part of the second main body is a polygonal column whose cross section is a polygon; the polygonal action part is locked with the mounting part so that the second main body will not rotate along radial direction in the mounting part of the first main body.

2. The device as claimed in claim 2, wherein a cross section of the action part is hexagonal.

3. The device as claimed in claim 1, wherein the mounting part is a hexagonal slot whose cross section is hexagonal.

4. The device as claimed in claim 1, wherein a driving part is arranged at the other end of the first main body and the driving part is a quadrilateral groove.

5. The device as claimed in claim 1, wherein a cross section of the mounting part of the first main body is irregular-shaped.

6. The device as claimed in claim 1, a connection part between the insertion hole and the assembly slot has a smaller diameter so as to prevent the locking member from falling into the assembly slot.

7. The device as claimed in claim 1, wherein the locking member is ball-shaped.

8. The device as claimed in claim 1, wherein the sleeve set includes a receiving means and a magnetic body; the receiving means having a receiving slot and an against part disposed on one end thereof while a diameter of the against part is larger than a diameter of the receiving means; the against part is against the second leaning surface of the second main body; the magnetic body is mounted in the receiving slot and having magnetic attraction; the magnetic body is aligned with the assembly slot of the second main body.

9. The device as claimed in claim 1, wherein the first main body includes an assembly end and a positioning hole is arranged at a circumferential side of the assembly end; the positioning hole is used for mounting a fixing member.

10. A tool joint comprising a first main body and a second main body; the first main body disposed with a mounting part at one end thereof; the mounting part including a front end close to an opening, and a stopping part that is a circular groove formed by the front end extended backward and having a front segment and a rear segment;
wherein a diameter of the front segment is smaller than a diameter of the rear segment and a rear part is arranged at a bottom end of the mounting part; the front end and the rear part are polygonal slots whose cross section is polygonal; the second main body that includes an enlarged end and an action part formed by the enlarged end extended backward; the action part is a polygonal column whose cross section is a polygon that matches a shape of the front end and a shape of the rear part of the mounting part of the first main body; the second body is mounted in the mounting part and is able to move axially in the mounting part without rotating along radial direction in the mounting part.

11. The device as claimed in claim 10, wherein a first elastic member is arranged in the mounting part of the first main body.

12. The device as claimed in claim 10, wherein a second elastic member is disposed in the mounting part of the first main body.

13. The device as claimed in claim 10, wherein the second main body includes an assembly slot and a sleeve set is disposed in the assembly slot.

14. The device as claimed in claim 13, wherein at least one insertion hole is arranged at the assembly slot, close to an opening end of the assembly slot.

15. The device as claimed in claim 14, wherein the insertion hole is mounted with a locking member and the locking member is ball-shaped.

16. The device as claimed in claim 10, wherein the first main body includes an assembly end and a positioning hole is arranged at a circumferential side of the assembly end; the positioning hole is used to load a fixing member.
